(19) United States
(12) Patent Application Publication
(10) Pub. No.: US 2026/0358187 A1
(43) Pub. Date: Nov. 12, 2026

(54) FORCE METERING MECHANISM FOR WIND TUNNELS

(71) Applicant: CELAL BAYAR UNIVERSITESI DIGER MERKEZLER MUDURLUGU, Manisa (TR)

(72) Inventors: Emre KIRAZ, Izmir (TR); Adnan Burak INCEDAL, Izmir (TR); Seda ARABACI, Izmir (TR)

(73) Assignee: CELAL BAYAR UNIVERSITESI DIGER MERKEZLER MUDURLUGU, Manisa (TR)

(21) Appl. No.: 19/135,116

(22) PCT Filed: Oct. 2, 2023
(86) PCT No.: PCT/TR2023/051055

§ 371 Date: Jun. 3, 2025

(30) Foreign Application Priority Data
Dec. 4, 2022 (TR) 2022/018481

(51) Int. Cl. G01M 9/06; G01M 9/04

(52) U.S. Cl. CPC G01M 9/062; G01M 9/04

(57) ABSTRACT

A force metering mechanism for keeping said test piece in said wind tunnel performs aerodynamic tests by exposing at least one test piece to the air flow in a wind tunnel in which air flow is provided in a flow direction. The force metering mechanism includes at least one piece holder enabling the test piece to be held by being fixed to at least one first extension, said piece holder includes at least one second extension connected to said first extension from at least one bearing point, the first extension and at least one of said second extension is free to rotate around said bearing point relative to the other in order to ensure that the test piece is kept at different angles with respect to the air flow and the floor of the test chamber.

### CROSS REFERENCE TO THE RELATED APPLICATIONS

This application is the national phase entry of International Application No. PCT/TR2023/051055, filed on Oct. 2, 2023, which is based upon and claims priority to Turkish Patent Application No. 2022/018481, filed on Dec. 4, 2022, the entire contents of which are incorporated herein by reference.

### TECHNICAL FIELD

The invention relates to a force metering mechanism for keeping said test piece in said wind tunnel in order to perform aerodynamic tests by exposing at least one test piece to the air flow in a wind tunnel in which air flow is provided in a flow direction.

### BACKGROUND

Wind tunnel tests are experiments of great importance for studies in the field of aerodynamics. The use of wind tunnels is important in the Defense Industry, the automotive sector and even the construction sector. In the results of the wind tunnel experiment, energy savings can be calculated together with aerodynamic forces. Aerodynamic property measurements can be performed in these wind tunnels in many areas such as air, land and sea vehicles, wind turbine blades or architectural structures exposed to wind load.

The test piece to be tested to perform said tests is positioned in the wind tunnel. A sensor that allows the metering of the load on the piece is connected to the test piece and an air flow is created in the tunnel and the test piece is exposed to this air flow. Connecting said sensor to the test piece is a laborious process according to the methods known in the present art.

In particular, in the tests of pieces belonging to the aviation sector, the test piece may need to be tested at different angles according to the air flow direction within the wind tunnel. Again, according to the methods known in the current art, in cases where such angle adjustment is required, the entire assembly must be adjusted from the beginning and the sensor must be reconnected to the test piece accordingly. As a result, since angle adjustment cannot be made for force metering, all these operations make it difficult to make the test piece ready for testing.

Application TR2021/006909 known in the literature This invention relates to the more reliable, realistic, and accurate metering of the wind vector (wind speed and direction) over a cylindrical object in two or three directions, considering the weather conditions, using force sensors, temperature sensor, humidity sensor and pressure sensor.

All the problems mentioned above have made it necessary to make an innovation in the relevant technical field as a result.

### SUMMARY

The present invention relates to a force metering system for eliminating the above-mentioned disadvantages and bringing new advantages to the related technical field.

An object of the invention is to provide a force metering mechanism in which the force metering can be provided by keeping the test piece at different angles to the air flow and the floor of the test chamber.

The present invention is a force metering mechanism for keeping said test piece in said wind tunnel in order to perform the aerodynamic tests by exposing at least one test piece to the airflow in a flow direction in order to realize all the objects that will emerge from the abovementioned and the following detailed description. Accordingly, its novelty includes at least one piece holder that allows the test piece to be held by fixing it to at least one first extension, said piece holder includes at least one second extension connected to said first extension from at least one bearing point, the first extension and at least one of said second extension have the freedom to rotate around said bearing point relative to the other in order to ensure that the test piece is kept at different angles according to the air flow and the floor of the test room. Thus, it is ensured that the test pieces are kept at different angles in the wind tunnel compared to the ground. Different conditions can be easily simulated in this way.

A possible embodiment of the invention is characterized in that it includes at least one fixing element to ensure that the first extension and the second extension are fixed after the angle between them is adjusted. Thus, it is ensured that the test piece can be fixed at the desired angle.

Another possible embodiment of the invention is characterized in that it includes at least one sensor to enable the metering of the force on the test piece under the air flow. Thus, the wind load on the test piece can be detected.

Another possible embodiment of the invention is characterized in that it includes a sensor holder with at least one sensor slot to enable said sensor to be held and connected to the test piece. Thus, it is ensured that the sensor can be associated with the test piece in order to make the relevant measurements.

Another possible embodiment of the invention is characterized in that said sensor holder includes at least one cable duct configured to position the cable providing power transmission of the sensor. Thus, a guide area for the cable is provided on the sensor holder.

Another possible embodiment of the invention is characterized in that it includes at least one cover to enable said sensor slot to form a volume isolated from the external environment. Thus, it is ensured that the sensor can perform a healthier metering.

### BRIEF DESCRIPTION OF THE DRAWINGS

FIG. 1 shows a representative exploded perspective view of the force metering mechanism of the invention.

FIG. 2 shows a representative exploded perspective view of the piece holder of the force metering mechanism of the invention.

### REFERENCE NUMBERS IN THE FIGURES

10 Force Metering Mechanism
20 Sensor Holder
21 Sensor Slot
22 Sensor Mounting Element
23 Cable Duct
24 Cover
25 Cover Mounting Element
30 Piece Holder
31 First Extension
311 Fixing Slot
32 Second Extension
33 Bearing Point
34 Fixing Element
35 Connection Element
40 Sensor

### DETAILED DESCRIPTION OF THE EMBODIMENTS

In this detailed description, the subject matter of the invention is explained only by means of examples that will not have any limiting effect for a better understanding of the subject matter.

The aerodynamic design of airfoils in aviation affects the performance of the entire blade, aircraft fuel, performance, and the overall performance of the wind turbine.

The effect of the force applied to the object in a fluid in the opposite direction is called the drag force. The drift coefficient, which is the most important feature among the parameters included in the drift force, is a dimensionless number. It is shown as C_{d} or as C_{D}. ρ is the density of the fluid, V is the velocity of the fluid, and A is the cross-sectional area perpendicular to the flow.

$${C}_{d} = \frac{{F}_{d}}{0.5 ρ {AV}^{2}}$$

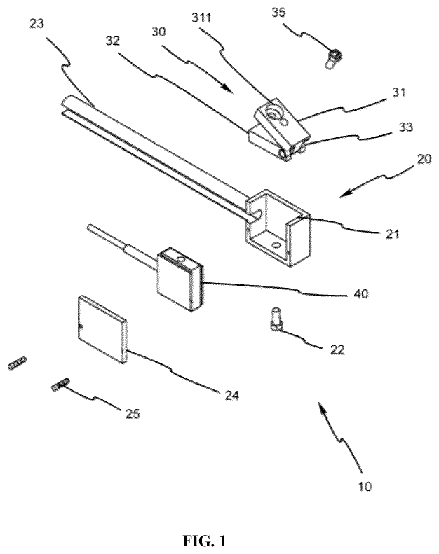

A representative exploded perspective view of the force metering mechanism (10) of the invention is given in FIG. 1. Said force metering mechanism (10) is used in the metering of the aerodynamic properties of at least one test piece. Accordingly, the force metering mechanism (10) is positioned in a wind tunnel (the test piece and the wind tunnel are not shown in the Figures).

Said wind tunnel is a room in which air flow is provided in one direction. Said test piece, whose aerodynamic properties are desired to be tested, is also exposed to airflow in this wind tunnel. The test piece can be a product of any sector (land, air, watercraft, turbine pieces, architectural structure models, etc.).

The force metering mechanism (10) includes at least one sensor holder (20). The sensor holder (20) is essentially an apparatus for metering the load on the test piece when it is exposed to the air flow in the wind tunnel. Accordingly, the force metering mechanism (10) includes at least one sensor (40). Said sensor (40) enables the metering and detection of the force on the test piece under the air flow. There is at least one sensor slot (21) on the force metering mechanism (10). The sensor (40) is essentially positioned in the sensor slot (21).

The value taken by the sensor (40) in the axis of the wind speed vector in the force metering mechanism (10) gives the drift force. The metering taken on the vertical axis gives the lifting (carrying) force. Lifting is the combination of the superficial forces generated by the fluid along the blade if a blade profile is considered. When airflow is generated at a certain speed around the blade, it is observed that a lower pressure occurs on the upper surface of the blade compared to the lower surface of the blade. If the pressure on the lower surface is high, a buoyancy force is obtained. The lifting force is shown as Fₗ. One of the most important parameters within the lifting force is the lifting coefficient. The lifting coefficient is also a dimensionless parameter and is expressed as Cₗ or C_{L}.

$${C}_{l} = \frac{{F}_{l}}{0.5 ρ {AV}^{2}}$$

The angle of rotation is the angle between the chord line of the airfoil and the flow lines. The critical angle for airfoils is usually 15°. The attack angles in fighter planes can vary between 20° and 45°. With the invention in the force metering mechanism, the angle of attack can be adjusted, and aerodynamic performance can be obtained.

The force metering mechanism (10) has at least one cable duct (23). The cable duct (23) includes a gap configured to allow the cable to pass through. Accordingly, the cable duct (23) allows the cable that provides power transmission to the sensor (40) to pass through it. The sensor holder (20) includes at least one cover (24) covering the sensor (40) in the sensor slot (21). The cover (24) is connected with at least one cover mounting element (25) on the sensor slot (21). The sensor mounting element (22) is essentially a bolt. There is at least one sensor mounting element (22) that allows the sensor (40) to be removably mounted to the sensor slot (21). The sensor mounting element (22) is essentially a bolt.

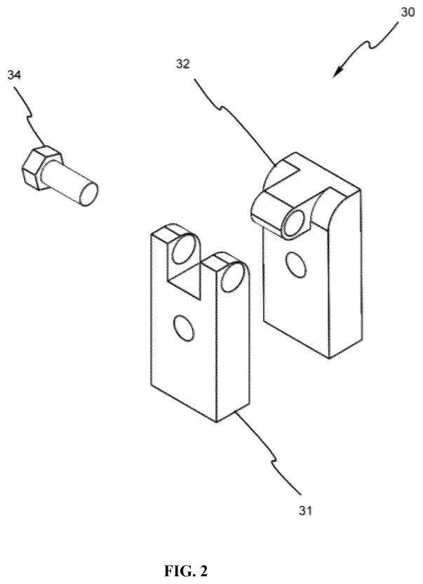

The force metering mechanism (10) includes at least one piece holder (30). The piece holder (30) enables the connection of the test piece to the force metering mechanism (10). In other words, the test piece to be subjected to the force metering test in the wind tunnel is connected to the piece holder (30). Accordingly, the piece holder (30) includes at least one first extension (31). Said first extension (31) is connected with at least one second extension (32). The first extension (31) and the second extension (32) are connected to each other from at least one bearing point (33). At least one of the first extension (31) and the second extension (32) has the ability to rotate relative to the other with respect to the bearing point (33). A representative exploded perspective view of the piece holder (30) is given in FIG. 2. Accordingly, at least one fixing element (34) is connected to the bearing point (33). Said fixing element (34) enables the first extension (31) and the second extension (32) to be fixed after their angles are adjusted relative to each other.

There is at least one second fixing slot (311) on the first extension (31). The test piece to be tested is fixed to the piece holder (30) by means of at least one connection element (35) connected to said fixing slot (311). The connection element (35) may be a bolt.

With the force metering mechanism (10) of the invention, the test piece can be held at different angles compared to the ground of the wind tunnel. For this, the test piece is first attached to the first extension (31) with the connection element (35). The first extension (31) is then fixed with the fixing element (34) when the test piece is brought to the desired angle with respect to the ground of the wind tunnel. In this way, it is ensured that the test piece is exposed to airflow at different angles. The sensor (40) in the force metering mechanism (10) also allows the force on the test piece to be measured during the test.

The force metering mechanism (10), which is the subject of the invention, offers ease of use with its compact structure. Different test pieces can be connected to the piece holder (30), and the connection of the sensor (40) with the test piece can be easily ensured with the compact structure of the sensor holder (20). However, with the force metering mechanism (10) of the invention, the angle of attack in the wind tunnel can be adjusted to the desired value. As a result, aerodynamic performances (Cₗ/C_{d}) corresponding to the angle of attack are obtained.

The scope of protection of the invention is specified in the attached claims and cannot be limited to those explained for sampling purposes in this detailed description. It is evident that a person skilled in the art may exhibit similar embodiments in light of above-mentioned facts without drifting apart from the main theme of the invention.

What is claimed is:

1. A force metering mechanism for keeping a test piece in a wind tunnel in order to perform aerodynamic tests by exposing the at least one test piece to an air flow in the wind tunnel in which the air flow in a direction of a flow is provided, comprising at least one piece holder configured to enable the test piece to be held by being fixed to at least one first extension,
the piece holder comprises at least one second extension connected with the first extension from at least one bearing point, and
at least one of the first extension and the second extension is free to rotate around the bearing point relative to the other in order to ensure that the test piece is kept at different angles compared to the air flow and a floor of a test chamber.

2. The force metering mechanism according to claim 1, further comprising at least one fixing element for fixing the first extension and the second extension after an angle between the first extension and the second extension has been adjusted.

3. The force metering mechanism according to claim 1, further comprising at least one sensor for measuring a force exerted on the test piece under air flow.

4. The force metering mechanism according to claim 1, further comprising a sensor holder having at least one sensor slot for holding a sensor and for contacting the sensor with the test piece.

5. The force metering mechanism according to claim 4, wherein the sensor holder comprises at least one cable duct configured such that a cable for power transmission to the sensor is positioned therein.

6. The force metering mechanism according to claim 4, further comprising at least one cover to enable a sensor slot to form a volume isolated from an external environment.

7. The force metering mechanism according to claim 5, further comprising at least one cover to enable a sensor slot to form a volume isolated from an external environment.
